(19) United States
(12) Patent Application Publication
(10) Pub. No.: US 2024/0179623 A1
(43) Pub. Date: May 30, 2024

(54) METHOD AND APPARATUS FOR CONNECTION BETWEEN TERMINAL AND BASE STATION IN MULTI-HOP NETWORKS

(71) Applicant: ELECTRONICS AND TELECOMMUNICATIONS RESEARCH INSTITUTE, Daejeon (KR)

(72) Inventors: Mi Young YUN, Daejeon (KR); Seong Jun KIM, Suwon-si (KR); Chan Won PARK, Suwon-si (KR); Je Min LEE, Suwon-si (KR)

(73) Assignee: ELECTRONICS AND TELECOMMUNICATIONS RESEARCH INSTITUTE, Daejeon (KR)

(21) Appl. No.: 18/522,907

(22) Filed: Nov. 29, 2023

(30) Foreign Application Priority Data
Nov. 29, 2022 (KR) 10-2022-0163515

(51) Int. Cl. H04W 48/20

(52) U.S. Cl. CPC H04W 48/20

(57) ABSTRACT

Disclosed are a method and apparatus for connecting a terminal and a base station in a multi-hop network. A method of a terminal may comprise: receiving cell selection and reselection criteria information broadcast from a base station; determining candidate base stations among all base stations capable of communicating with the terminal based on the cell selection and reselection criteria information; selecting one connection scheme from a lightening backhaul load (LBL) scheme or a maximum reference signal received power (RSRP) scheme based on a tolerable gap, which is a parameter for determining the candidate base station; selecting one candidate base station from among the candidate base stations as a target base station based on the one connection scheme; and connecting to the target base station.

### CROSS-REFERENCE TO RELATED APPLICATIONS

This application claims priority to Korean Patent Application No. 10-2022-0163515, filed on Nov. 29, 2022, with the Korean Intellectual Property Office (KIPO), the entire contents of which are hereby incorporated by reference.

### BACKGROUND

### 1. Technical Field

The present disclosure relates to connection technology between a terminal and a base station in a communication system, and more specifically to connection technology for connecting a terminal to a base station in a wireless multi-hop network.

### 2. Related Art

A three-dimensional (3D) spatial mobile communication system can provide mobile communication services to aerial terminals. Terminals may refer to terrestrial terminals and/or aerial terminals. The terrestrial terminals may refer to mobile terminals on the ground. The aerial terminals may refer to mobile terminals in the air. The aerial terminals include terminals such as air taxis, drones, and aircraft. A base station may need to provide mobile communication services for aerial terminals. The base station may include a terrestrial base station and a non-terrestrial base station. In addition, the base station may utilize a multi-hop wireless backhaul topology to provide mobile communication services to terminals.

In an existing cellular-based terrestrial network, when a terminal is connected to a base station, cell selection and reselection procedures may be performed based on reference signal received power (RSRP). On the other hand, in a network to which multi-hop wireless backhaul is applied, the terminal can select the base station based on RSRP. However, when the terminal selects the base station based on RSRP, it may increase the overall interference in the wireless backhaul network, leading to a degradation in system performance of the terminal. In addition, when the terminal selects the base stations based on RSRP, the network may have difficulty in providing stable services.

### SUMMARY

Accordingly, example embodiments of the present invention provide a method and apparatus for connecting a terminal and a base station in a multi-hop network.

According to a first exemplary embodiment of the present disclosure, a method of a terminal may comprise: receiving cell selection and reselection criteria information broadcast from a base station: determining candidate base stations among all base stations capable of communicating with the terminal based on the cell selection and reselection criteria information: selecting one connection scheme from a lightening backhaul load (LBL) scheme or a maximum reference signal received power (RSRP) scheme based on a tolerable gap, which is a parameter for determining the candidate base station: selecting one candidate base station from among the candidate base stations as a target base station based on the one connection scheme: and connecting to the target base station.

The determining of the candidate base stations among all base stations capable of communicating with the terminal based on the cell selection and reselection criteria information may include: selecting a base station whose RSRP, which is a measurement result of a reference signal (RS) received from the base station, is greater than or equal to a first threshold: and selecting a candidate base station whose reference signal received quality (RSRQ), which is the measurement result of the RS received from the base station, is greater than or equal to a second threshold from the base station whose RSRP is greater than or equal to the first threshold.

The selecting of the one candidate base station from among the candidate base stations as the target base station based on the one connection scheme may include: selecting one or more candidate base stations from among the candidate base stations based on a quality threshold that is the received signal for all base stations, when selecting the LBL scheme; and selecting the target base station from among the one or more candidate base stations.

The selecting of the target base station from among the one or more candidate base stations may include: connecting the base station with the largest selection criterion value for selecting the target base station among the one or more candidate base stations as the target base station.

The method may further comprise: calculating the selection criterion value based on at least one of a cell selection parameter, backhaul information, or the quality threshold.

The tolerable gap may be a ratio of the quality threshold, which is the received signal for all base stations, and the RSRP received from the base station.

The tolerable gap may be the number of upper base stations in a ranking of the base stations based on the quality threshold that is the received signal for all base stations.

According to a second exemplary embodiment of the present disclosure, a method of a base station may comprise: transmitting a network environment parameter to a central server; receiving a tolerable gap, which is a parameter for determining a candidate base station, from the central server to maximize the performance of a network metric set based on the network environment parameter: generating cell selection and reselection information based on the network environment parameter and the tolerable gap; and transmitting the cell selection and reselection information to a terminal.

The network metric may be generated based on a probability of communication success, which is a probability that the capacity of the terminal is greater than the capacity of the target service.

The tolerable gap may be a ratio of a quality threshold, which is a received signal for all base stations capable of communicating with the terminal, and an RSRP received from the base station.

The tolerable gap may be the number of upper base stations in a ranking of base stations based on the quality threshold, which is a received signal for all base stations capable of communicating with the terminal.

According to a third exemplary embodiment of the present disclosure, a terminal may comprise: at least one processor, wherein the at least one processor may cause the terminal to receive cell selection and reselection criteria information broadcast from a base station; determine candidate base stations among all base stations capable of communicating with the terminal based on the cell selection and reselection criteria information; select one connection scheme from a lightening backhaul load (LBL) scheme or a maximum reference signal received power (RSRP) scheme based on a tolerable gap, which is a parameter for determining the candidate base station; select one candidate base station from among the candidate base stations as a target base station based on the one connection scheme; and connect to the target base station.

When the candidate base stations are determined among all base stations capable of communicating with the terminal based on the cell selection and reselection criteria information, the at least one processor may cause the terminal to select a base station whose RSRP, which is a measurement result of a RS received from the base station, is greater than or equal to a first threshold: and select a candidate base station whose RSRQ, which is the measurement result of the RS received from the base station, is greater than or equal to a second threshold from the base station whose RSRP is greater than or equal to the first threshold.

When one candidate base station is selected from among the candidate base stations as the target base station based on the one connection scheme, the at least one processor may cause the terminal to select one or more candidate base stations from among the candidate base stations based on a quality threshold that is the received signal for all base stations, when selecting the LBL scheme; and select the target base station from among the one or more candidate base stations.

When the target base station is selected from among the one or more candidate base stations, the at least one processor may cause the terminal to connect the base station with the largest selection criterion value for selecting the target base station among the one or more candidate base stations as the target base station.

The at least one processor may cause the terminal to calculate the selection criterion value based on at least one of a cell selection parameter, backhaul information, or the quality threshold.

The tolerable gap may be a ratio of the quality threshold, which is the received signal for all base stations, and the RSRP received from the base station.

The tolerable gap may be the number of upper base stations in a ranking of the base stations based on the quality threshold that is the received signal for all base stations.

According to the present disclosure, it is possible to minimize the performance degradation of terminals in a network that supports multi-hop wireless backhaul. In addition, the present disclosure can propose criteria and application methods for cell selection and reselection for a terminal that can optimize the overall communication performance. The criteria and application methods for cell selection and reselection can alleviate interference with respect to the terminal to provide stable communication services.

### BRIEF DESCRIPTION OF DRAWINGS

FIG. 1 is a conceptual diagram illustrating an embodiment of an integrated access and backhaul (IAB) network structure.

FIG. 2 is a block diagram illustrating an embodiment of a communication node included in an IAB network.

FIG. 3 is a conceptual diagram illustrating a connection state between a terminal and a base station.

FIG. 4 is a conceptual diagram illustrating the transmission information of a base station.

FIG. 5 is a flowchart illustrating an embodiment of a method of configuring a tolerable gap.

FIG. 6 is a flowchart illustrating a first embodiment of a method for connecting a terminal and a base station.

FIG. 7 is a flowchart illustrating a second embodiment of a method for connecting a terminal and a base station.

FIG. 8 is a flowchart illustrating a third embodiment of a method for connecting a terminal and a base station.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system or a memory system to which exemplary embodiments according to the present disclosure are applied will be described. The communication system or memory system to which the exemplary embodiments according to the present disclosure are applied is not limited to the content described below, and the exemplary embodiments according to the present disclosure can be applied to various communication systems. Here, the communication system may be used in the same sense as a communication network.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

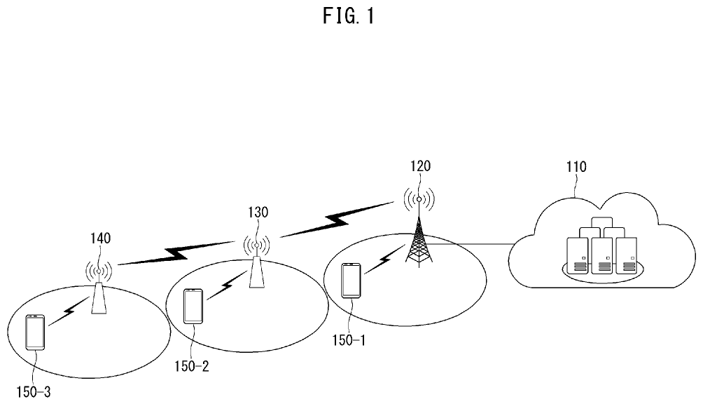

FIG. 1 is a conceptual diagram illustrating an embodiment of an integrated access and backhaul (IAB) network structure.

Referring to FIG. 1, the IAB network may include a core network 110, an IAB donor 120, and/or at least one IAB node 130 and 140. When the IAB network 100 supports 4G communication, the core network 110 may include a serving gateway (S-GW), a packet data network (PDN) gateway (P-GW), and a mobility management entity (MME), etc. When the IAB network supports 5G communication, the core network may include a user plane function (UPF), a session management function (SMF), and an access and mobility management function (AMF).

The IAB donor 120 and/or the at least one IAB node 130 and 140 may support 4G communication (e.g., LTE, LTE-A), 5G communication (e.g., NR), 6G communication, etc., which are defined in the 3GPP standard. The IAB network 100 may also include at least one terminal 150-1, 150-2, and 150-3. Meanwhile, each of the IAB donor 120 and/or the at least one IAB node 130 and 140 may operate in different frequency bands, or operate in the same frequency band. The IAB donor 120 and/or the at least one IAB node 130 and 140 may be connected to each other through a backhaul link. The IAB donor 120 and/or the at least one IAB node 130 and 140 may be connected to the core network 110 through a backhaul link. Each of the IAB donor 120 and/or the at least one IAB node 130 and 140 may transmit signals received from the core network to the corresponding terminals 150-1, 150-2, and 150-3, and transmit signals received from the terminals 150-1, 150-2, and 150-3 to the core network 110.

Here, similar to the split architecture of a central unit (CU)/distributed unit (DU) in a 5G radio access network (RAN), the IAB donor 120 may be responsible for central control functions, including overall path establishment, topology management, handover, routing path establishment for data, and mapping of wireless bearers. The IAB nodes 130 and 140 may transmit data. Alternatively, the IAB nodes 130 and 140 may provide services to terminals 150-2 and 150-3. The IAB donor 120 may have a wired link with the core network 110 and act as a base station for the IAB node 130 and the terminal 150-1 connected to the IAB network.

The IAB donor 120 may be connected to the core network 110 through a wired interface and may be connected to the IAB node 130 through a wireless interface. The IAB node 130 may be connected to the IAB node 140 and the IAB donor 120 through a wireless interface, and act as a relay node for the IAB node 140 on the downstream link and for the IAB donor 120 on the upstream link.

The IAB node 140 may be connected to the IAB node 130 to provide services to the terminal 150-3, and operate in conjunction with the IAB node 130 for data transmission/reception. A backhaul adaptation protocol (BAP) may be used for data relay transmission between the IAB donor 120 and the IAB node 130 or between the IAB nodes 130 and 140. The BAP may perform a multi-hop data relay function, a mapping function of an ingress RLC channel and an egress RLC channel, and a routing function, based on a radio link control (RLC) channel.

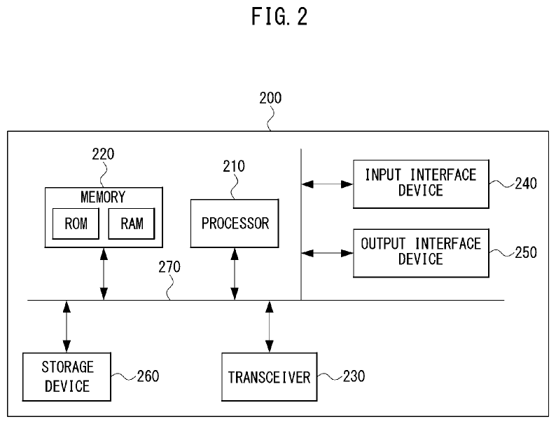

FIG. 2 is a block diagram illustrating an embodiment of a communication node included in an IAB network.

Referring to FIG. 2, the communication node 200 included in the IAB network may include at least one processor 210, a memory 220, and/or a transmission/reception module 230. The above-described communication node 200 may refer to one of the IAB donor and the IAB node. The above-described processor 210 may receive information about time resources divided into a plurality of time resources through the transmission/reception module 230 in order to transmit and receive signals and transmit the above-described signal from one of the above-described plurality of divided time resources through the transmission/reception module 230, and one time resource described above may be determined based on an IAB node list. The above-described transmission/reception module 230 may be referred to as a transceiver, a radio frequency (RF) unit, an RF module, etc. In addition, the communication node 200 may further include an input interface device 240, an output interface device 250, and/or a storage device 260. Each component included in the communication node 200 may be connected by a bus 270 to communicate with each other.

However, each component included in the communication node 200 may be connected through an individual interface or individual bus centered on the processor 210, rather than the common bus 270. For example, the processor 210 may be connected to at least one of the memory 220, the transmission/reception module 230, the input interface device 240, the output interface device 250, and/or the storage device 260 through a dedicated interface.

The processor 210 may execute a program command stored in at least one of the memory 220 and the storage device 260. The processor 210 may refer to a central processing unit (CPU), a graphics processing unit (GPU), and/or a dedicated processor on which methods according to embodiments of the present disclosure are executed. The memory 220 and/or the storage device 260 may be composed of at least one of a volatile storage medium and/or a non-volatile storage medium. For example, the memory 220 may be composed of a read only memory (ROM) and/or a random access memory. Next, the integrated access and backhaul (IAB) network will be described. In a communication system, a high density of cells may be required to ensure service coverage, which may require the installation of many base stations and high maintenance costs. Therefore, wireless backhauling technology can replace optical cables at low cost, and integrated access and backhaul (IAB) network technology can be used for the wireless backhauling technology. The IAB network may flexibly provide multi-hop-based wireless backhaul at effective costs compared to wired backhaul.

Meanwhile, the IAB nodes can be broadly divided into fixed IAB nodes and mobile IAB nodes. The fixed IAB nodes may be used to cost-effectively cover service coverage holes. Alternatively, the fixed IAB nodes may be used to temporarily provide service coverage to a specific area. The mobile IAB nodes may be installed on various mobile objects such as vehicles, trains, and drones, and used to provide services to devices of passengers on board or embedded Internet of things (IoT) devices. The mobile IAB node may be referred to as a movable IAB node.

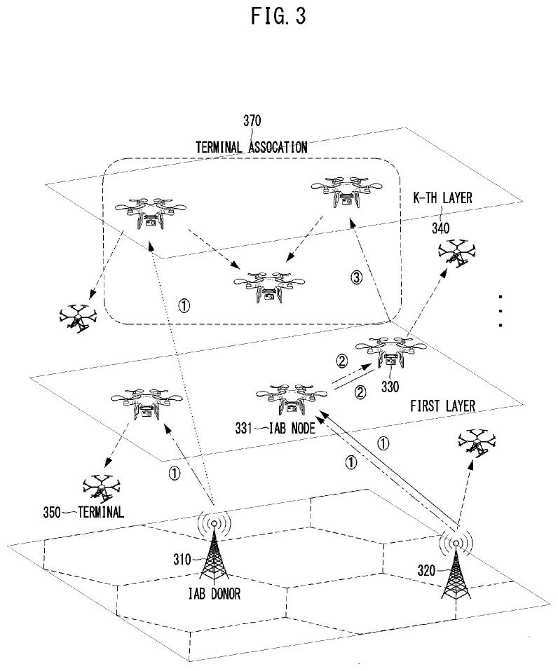

FIG. 3 is a conceptual diagram illustrating a connection state between a terminal and a base station.

Referring to FIG. 3, the present disclosure can be applied to a network in which multi-hop connections are supported. FIG. 3 may illustrate a method of connecting a terminal to a base station and a network environment for a device to operate in a network in which multi-hop is supported. The network in which the multi-hop connection is supported may include an IAB network in which multi-hop is supported. In the IAB network, the terminal may perform a connection procedure with the base station. The IAB network may include at least one of a plurality of terrestrial base stations, a plurality of aerial base stations, a plurality of aerial terminals, or a central server.

The terrestrial base station may be referred to as an IAB donor 310. The IAB donor may be used interchangeably with a wiredly connected base station. The wiredly connected base station may be connected to the central server by wire. The IAB donor may transmit and receive signals or commands to and from the central server. The IAB donor may be connected wirelessly to the IAB node 330, which is a wirelessly connected base station.

The aerial base station may be referred to as an IAB node. The IAB node 330 may be used in the same sense as a wirelessly connected base station. The IAB node 330 may be distributed on at least one of the ground or air (non-ground). In addition, the IAB node 330 may be distributed in a layer to service an aerial terminal 350 in some cases. The layer may refer to an area corresponding to the air. IAB nodes 330 may be distributed across multiple layers depending on the network environment. The IAB nodes 330 may be distributed on the same layer depending on the network environment.

The IAB node 330 may be connected to the IAB donor 310, which is a terrestrial base station, through wireless backhaul, and may be connected to the central server. The IAB node 330 may be connected to another aerial base station 331 through wireless backhaul and connected to a central server. The other aerial base station 331 may be connected to an IAB donor 320. The IAB node 330 may be connected to the IAB donor 310 through wireless backhaul, and transmit and receive signals or commands to and from the central server. Alternatively, the IAB node 330 may be connected to the IAB node 331, which is already connected to the IAB donor 310, through wireless backhaul, and transmit and receive signals or commands to and from the central server.

The IAB node 330 may perform a backhaul connection procedure with an upper base station. The IAB node 330 may perform a procedure to determine whether to establish a backhaul connection with an arbitrary upper base station. A method of determining whether the IAB node 330 will establish a backhaul connection with an arbitrary upper base station may be referred to as an upper base station connection scheme. The IAB node 330 may be connected to the upper base station through backhaul over several hops. The upper base station connection scheme may be as shown in the following examples.

The upper base station connection scheme may include a method of connecting to the nearest IAB donor. The upper base station connection scheme may include connecting to another IAB node that is already connected to the IAB donor. The upper base station connection scheme may include a method of connecting to a base station with the largest capacity to the central server among upper base station candidates. The upper base station connection scheme may not be limited to these examples. The upper base station connection scheme may use various methods as a backhaul connection technique for the IAB node 330.

The aerial terminal 350 may be distributed in various forms. For example, terminals to be deployed in the network may be distributed on the ground or in the air (non-ground).

The central server may control the operations of the base stations. In the present disclosure, an area supported by wiredly and wirelessly connected base stations controlled by the central server may be referred to as the network of the central server. The central server may collect information by receiving signals from each wiredly or wirelessly connected base station. The information collected by the central server may refer to at least one of information about the transmission power of the base station, the density of the base stations, the height of the base station, the density of terrestrial and aerial terminals that communicate within a cell, and the height of the terminals within the network area of the central server. In addition, the central server may collect environment parameters within the network. The network environment parameters may refer to all parameters that determine the environment within the network area. For example, the network environment parameters may include a ratio of an area occupied by obstacles (buildings, etc.) that determine the channel of a transmission/reception node, the number of obstacles in the network area, an average height of obstacles in the network, an average density of obstacles, etc. The network environment parameters may be organized through separate research and stored as pre-configured values in the database of the central server. In addition, the network environment parameters may be collected through communication with base stations within the network.

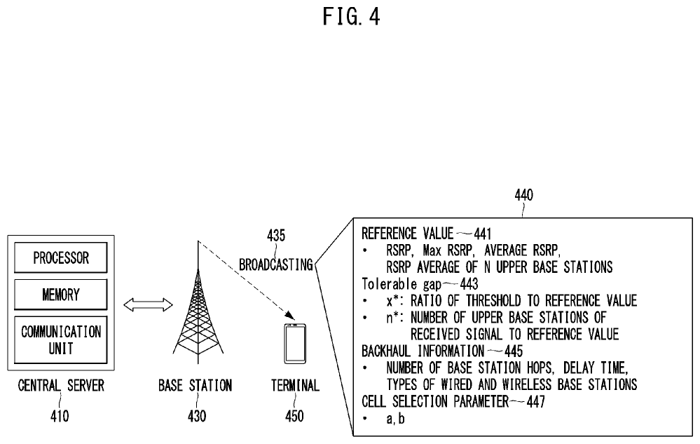

FIG. 4 is a conceptual diagram illustrating the transmission information of a base station.

Referring to FIG. 4, FIG. 4 may show cell selection and reselection criteria information in the wireless multi-hop backhaul network proposed in the present disclosure. A wireless multi-hop backhaul network may refer to an area supported by wired and wirelessly connected base stations controlled by a central server. The wireless multi-hop backhaul network may be referred to as a network. The wireless multi-hop backhaul network may include a central server 410, a base station 430, and a terminal 450. The base station 430 may transmit cell selection and reselection criteria information 440 to the terminal.

The central server 410 may receive signals from each wiredly or wirelessly connected base station. In addition, the central server 410 may receive at least one of information about the transmission power of the base station, the density of the base stations, the height of the base station, the density of terrestrial and aerial terminals that communicate within the cell, or the height of the terminals within the network area of the central server. In addition, the central server 410 may acquire network environment parameters. The central server 410 may transmit the acquired network environment parameters to the base station.

The network environment parameters may be acquired through separate research. Alternatively, the network environment parameters may be stored as pre-configured values in the database of the central server. The network environment parameters may be acquired through communication with the base stations in the network. Here, the network environment parameters may refer to all parameters that determine the environment within the network area. For example, the network environment parameters include at least one of a ratio of an area occupied by obstacles (buildings, etc.) that determine a channel of a transmission/reception node, the number of obstacles within the network area, an average height of obstacles within the network, or an average density of obstacles.

The base station 430 may be connected to the central server via wireless backhaul. The base station 430 may receive the network environment parameters transmitted by the central server 410. The base station 430 may generate cell selection and reselection criteria information based on the network environment parameters. The base station may broadcast the generated cell selection and reselection criteria information (435), and transmit the information to the terminal 450. The base station may refer to an aerial base station or a terrestrial base station. In addition, the base station may refer to a wiredly connected base station or a wirelessly connected base station. When the base station does not broadcast or transmit the cell selection and reselection criteria information to the terminal, the base station may transmit a pre-configured value to the terminal 450.

The cell selection and reselection criteria information 440 may refer to information used by the terminal in cell selection and reselection procedures. The cell selection and reselection criteria information may include at least one of a reference value 441, a tolerable gap value 443, backhaul information 445, or a cell selection criteria parameter. The cell selection and reselection criteria information 440 may be transmitted from the base station to the terminal by broadcasting (435). In addition, the cell selection and reselection criteria information 440 may be a pre-configured value in some cases.

The reference value 441 may be referred to as a standard threshold. The standard threshold may include information about signal strength. The standard threshold may include at least one of RSRP, RSRP with the largest signal (Max RSRP), average RSRP of the base station, and average RSRP of n upper base stations with a large received signal. The RSRP may refer to the signal strength for each base station collected from the terminal. Bits that can designate the standard threshold may be transmitted from the base station to the terminal by broadcasting. In other words, the standard threshold received by the terminal may be transmitted from the base station by broadcasting. In addition, the standard threshold received by the terminal may be set as a pre-configured value. In addition, when the standard threshold has not been set, the default value of the standard threshold may be set to the largest reception RSRP (Max RSRP).

The tolerable gap 443 may refer to a parameter introduced to determine a candidate base station or select a cell for a terminal in a wireless network supporting multi-hop. The tolerable gap 443 may include at least one piece of x* or n* information. x* may denote a ratio of the standard threshold and RSRP value received from the terminal. n* may denote the number of upper base stations for received signals relative to the standard threshold. In other words, n* may denote the number of upper base stations in the ranking of base stations based on the standard threshold. For example, when n* is 3, the number of the upper base stations in the ranking of base stations based on the standard threshold is 3.

x* of the tolerable gap may be a concept of a ratio that serves as a threshold that ensures that a ratio of the received signal of a target base station to the standard threshold is greater than a predetermined value.

n* of the tolerable gap may be a concept of selecting n upper base stations with respect to the standard threshold as candidate base stations. n* may denote the number of base stations. At this time, when the number of base stations satisfying the standard threshold is less than n, the number of candidate base stations may be less than n. n* may allow the terminal to select only base stations within a required range as candidate base stations, rather than selecting all cells as selection candidates when selecting a cell.

Meanwhile, the candidate base station may be determined based on the standard threshold. The candidate base station may be determined based on the largest received RSRP value (Max RSRP). The candidate base station may be determined based on an average RSRP value of all base stations. The candidate base station may be determined based on the average of the n upper RSRP values with large received signals. The candidate base station may be determined based on the RSRP value and a reference signal received quality (RSRQ) value. The candidate base station may be selected from among all base stations. All base stations may refer to base stations with which a terminal can communicate.

When the value of n* is large, many base stations may be included as candidates when selecting a cell for the terminal. On the other hand, when the value of n* is small, relatively few base stations may be included as candidates when selecting a cell for the terminal.

The tolerable gap value may be broadcast from the base station and transmitted to the terminal. In addition, the tolerable gap value may be configured as a pre-configured value and transmitted.

The backhaul information 445 may refer to information related to the number of wireless backhaul hops. The base station may provide the terminal with backhaul information connected to the central server. The base station may provide backhaul information to the terminal. The base station and the terminal may determine cell selection and reselection of the terminal based on the backhaul information. The backhaul information may include actual connected multi-hop values. The backhaul information 445 may include at least one of the number of backhaul connection hops of each base station, the type of each base station (wiredly connected base station or wirelessly connected base station), or delay time information. The delay time information may refer to the time it takes for the terminal to receive a signal from the central server. The type of each base station may refer to information indicating whether the cell is a wiredly connected base station or a wirelessly connected base station. The backhaul information may include all information related to multi-hop (which may include directly or indirectly the number of hops in the cell). All information related to multi-hop may be transmitted from the base station to the terminal by broadcasting. All information related to multi-hop may be pre-configured and stored in the terminal in some cases.

All information transmitted from the base station to the terminal may be broadcast and transmitted. In some cases, all information transmitted from the base station to the terminal may be stored as pre-configured values in the base station.

The terminal 450 may perform cell selection and reselection procedures based on the standard threshold transmitted by the base station. When performing the cell selection and reselection procedure, the terminal 450 may select and reselect a cell based on the tolerable gap. In the present disclosure, cell selection and reselection of the terminal may refer to an operation of selecting or connecting the base station according to the base station selection and reselection criteria information.

The selection and reselection procedures of the terminal may include all cases where the terminal connects to a new network or disconnects from another existing cell and selects a different cell. For example, there may be the following cases: the cell selection and reselection procedures of the cell may include a case where the terminal selects a cell upon initial access to the network. In addition, the cell selection and reselection procedure may include a case where the current signal reception state of the terminal deviates from the cell criteria and cell reselection is performed. The cell selection and reselection procedure may include a case where handover occurs due to the mobility of the terminal or channel volatility. In addition, the cell selection and reselection procedure may include a case where cell access is performed when switching from an idle mode to a connected mode. The cell selection and reselection procedure may include a case where cell access is performed when switching from an inactive mode to the connected mode.

Meanwhile, the terminal 450 may determine candidate base stations to be connected to the base station. The candidate base stations may be determined using various criteria. For example, according to the criteria currently applied in NR cell selection, the base station in which both reference signal received power (RSRP) and reference signal received quality (RSRQ) values are greater than the threshold may be determined as a candidate base station when selecting a cell. As another example, when selecting a cell, among base stations whose RSRP and RSRQ values are each greater than a separate threshold, a base station that satisfies the criteria by the tolerable gap may be determined as the candidate base station. As another example, the base station that satisfies the criteria for the tolerable gap, regardless of the RSRP and RSRQ values, may be determined as the candidate base station when selecting a cell. The threshold may denote an integer including 0. In addition, the threshold may be referred to as a first threshold or a second threshold. The first threshold and the second threshold may refer to separate and different thresholds. As another example, base stations for which a value obtained by dividing the standard threshold by the transmission RSRP of the base station is less than or equal to the tolerable gap may be referred to as candidate base stations.

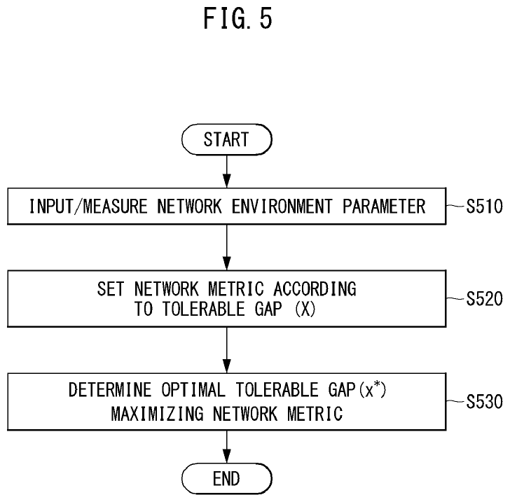

FIG. 5 is a flowchart illustrating an embodiment of a method of configuring a tolerable gap. Referring to FIG. 5, the central server may input and/or measure network environment parameters in operation S510. In other words, the central server may collect or measure the network environment parameters from the base station. In addition, the central server may store the network environment parameters in advance. The central server may calculate a tolerable gap (x* or n*) based on the network environment parameters. The tolerable gap calculated by the central server may refer to an optimal tolerable gap to maximize network communication performance.

The central server may set a network metric based on the tolerable gap in operation S520. The central server may use various network metrics to maximize network communication performance. For example, the network metric may be defined as the communication performance of a network. The network metric may be defined as the communication performance of the network, such as the probability of communication success or the total data rate for all terminals. The probability of communication success may be defined as the probability that the capacity of a specific (typical) terminal is greater than a target data rate from the perspective of average communication performance. In other words, the probability of communication success may refer to the probability that the service capacity of the current terminal is greater than the capacity of a target service. When the current service capacity of the terminal is greater than the capacity of the target service, the terminal may successfully communicate. The probability of communication success may refer to a value obtained by dividing the target data rate by the system capacity of the terminal. Communication performance may be optimized when the probability of communication success has a maximum value. In addition, communication performance may be optimized when the total data rate has a maximum value.

The central server may determine an optimal tolerable gap that maximizes the network metric in operation S530. When the optimal value of the tolerable gap cannot be obtained in a closed form, the central server may be designed to find the optimal solution through an algorithm by finding the optimal tolerable gap. The algorithm may include an exhaustive search algorithm, etc.

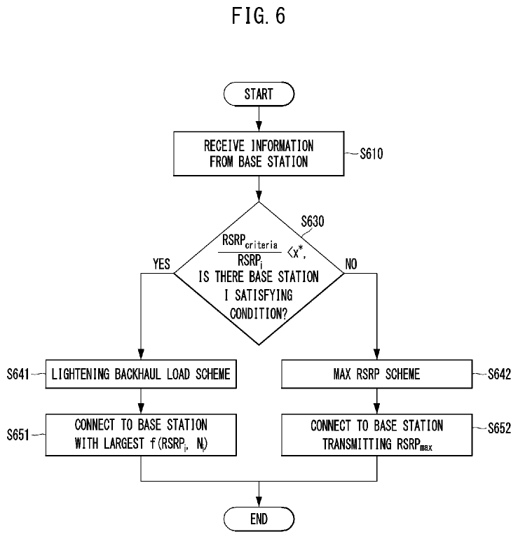

FIG. 6 is a flowchart illustrating a first embodiment of a method for connecting a terminal and a base station.

Referring to FIG. 6, the present disclosure may relate to a method for a terminal to perform a cell selection and reselection procedure based on information collected from a base station. The central server may transmit information to base stations. When exchanging various pieces of information such as channel information with a terminal, the base station may transmit an optimal tolerable gap value.

The terminal may receive information transmitted from the base stations in operation S610. The information received by the terminal may refer to a standard threshold. The information received by the terminal may refer to bits that specify the standard threshold. The terminal may perform the cell selection and reselection procedure based on the standard threshold.

The standard threshold may be used to determine candidate base stations. The terminal may determine the cell based on the standard threshold and/or the tolerable gap value. A cell selection method may refer to either a lightening backhaul load (LBL) scheme or a max RSRP (Max RSRP) scheme.

The terminal may use Equation 1 to select the LBL scheme or the maximum RSRP scheme. The terminal may calculate whether there is base station i that satisfies Equation 1 in operation S630. Equation 1 may be as follows.

$$\frac{{RSRP}_{criteria}}{{RSRP}_{i}} < {x}^{*} \qquad [ Equation 1 ]$$

RSRP_{criteria} denotes a standard threshold received by the terminal. x* may denote a ratio of a threshold to the standard threshold. RSRPᵢ may denote an RSRP value for base station i.

In addition, the terminal may select either the LBL scheme or the maximum RSRP scheme based on n*. The terminal may select either the LBL scheme or the maximum RSRP scheme based on n* through Equation 2. Equation 2 may be as follows.

$$\frac{{RSRP}_{criteria}}{{RSRP}_{i}} < {n}^{*} \qquad [ Equation 2 ]$$

Based on the collected standard threshold, when there is at least one base station that provides an RSRP greater than a predetermined percentage (tolerable gap, x) of the standard threshold, excluding the base station that provides the largest RSRP, the terminal may select the LBL scheme in operation S641.

The LBL scheme may be a method of selecting a cell with the largest selection criterion value from a candidate base station. The LBL scheme may determine the selection standard value determined in the LBL scheme based on backhaul information of each cell. The selection criterion value may denote a cell selection criterion value. The selection criterion value may refer to a standard for selecting a base station among candidate base stations in the LBL scheme.

The terminal may determine candidate base stations based on the LBL scheme as follows. The terminal may determine cells whose ratio between the standard threshold and the transmission RSRP of the base station is less than or equal to a tolerable gap value as candidate base stations. The candidate base station may refer to a base station whose ratio between the standard threshold and the transmission RSRP of the base station is less than or equal to the tolerable gap value. In addition, the terminal may determine n* base stations as candidate base stations. The candidate base stations may refer to n upper base stations for received signals based on the standard threshold.

In the LBL scheme, the selection criterion value for cell selection may use the RSRP value of each base station or values that can be expressed as ƒ(RSRPᵢ, Nᵢ). ƒ(RSRPᵢ, Nᵢ) may denote a function regarding the number of backhaul hops. RSRPᵢ may denote the received RSRP value of base station i. Nᵢ may denote the number of wireless backhaul hops. Nᵢ can be replaced with information about the type of each base station instead of the number of wireless backhaul hops. For example, Nᵢ for a wirelessly connected base station may be 1. In addition, Nᵢ for a wiredly connected base station may be 2. In addition, Nᵢ can be replaced by the delay time required to transmit data from the central server. The selection criterion value may be defined as an RSRP value or a combination of ƒ(RSRPᵢ, Nᵢ). In addition, the selection criterion value may be determined based on a cell selection parameter 447. For example, the selection criterion value can be expressed as Equation 3 or Equation 4. Equation 3 and Equation 4 may be as follows.

$${RSRP}_{i} + {\{ \frac{a}{{N}_{i} + 1} \}}^{b} \qquad [ Equation 3 ]$$

$${RSRP}_{i} \times {\{ \frac{a}{{N}_{i} + 1} \}}^{b} \qquad [ Equation 4 ]$$

The cell selection parameter may further include a design parameter. The cell selection parameter may determine the selection criterion value based on the design parameter. a and b may be included in the cell selection parameter. In other words, a and b may be the design parameters that determine the selection criterion value. The design parameter may refer to a weight. The weight may be configured arbitrarily. a and b are broadcast as values set by the base station and may be received by the terminal. When a and b are not provided, the terminal may use pre-configured values.

The terminal may select the LBL scheme and may be connected to a base station with the largest value of ƒ(RSRPᵢ, Nᵢ) in operation S651. The base station with the largest value of ƒ(RSRPᵢ, Nᵢ) may be referred to as a target base station.

Meanwhile, based on the collected standard threshold, when there is no base station that provides an RSRP above a predetermined percentage (tolerable gap, x) of the standard threshold except for the base station that provides the largest RSRP, the terminal may select the Max RSRP scheme in operation S642.

The Max RSRP scheme may be a method of selecting the cell that provides the largest RSRP. The terminal may select the Max RSRP scheme and may be connected to the base station that has transmitted RSRPₘₐₓ in operation S652. The base station that has transmitted RSRPₘₐₓ may be referred to as the target base station.

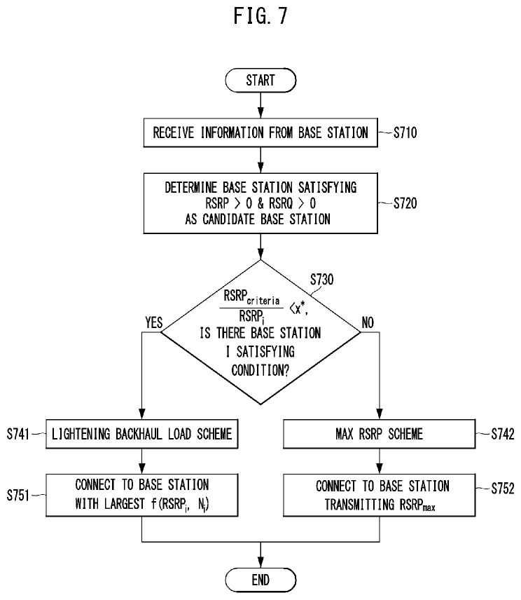

FIG. 7 is a flowchart illustrating a second embodiment of a method for connecting a terminal and a base station.

Referring to FIG. 7, the present disclosure may relate to a method for a terminal to perform a cell selection and reselection procedure based on information collected from a base station. FIG. 7 may illustrate the cell selection and reselection procedure based on NR.

The terminal may receive information transmitted from base stations in operation S710. The information received by the terminal may refer to a standard threshold. The information received by the terminal may refer to bits that specify a standard threshold. The terminal may perform the cell selection procedure based on the standard threshold.

Based on the standard threshold, the terminal may determine the base station with both RSRP and RSRQ greater than a threshold as a candidate base station in operation S720.

In addition, the standard threshold may be used to determine candidate base stations. The terminal may determine a cell selection method based on the standard threshold and/or a tolerable gap value. The terminal may select either a lightening backhaul load (LBL) scheme or a Max RSRP (Max RSRP) scheme to select a cell.

The terminal may use Equation 1 to select the LBL scheme or the maximum RSRP scheme. The terminal may calculate whether there is base station i that satisfies Equation 1 in operation S730.

In addition, the terminal may select either the LBL scheme or the maximum RSRP scheme based on n*. The terminal may select either the LBL scheme or the maximum RSRP scheme based on n* through Equation 2.

Based on the collected standard threshold, when there is at least one base station that provides an RSRP greater than a predetermined percentage (tolerable gap, x) of the standard threshold, excluding the base station that provides the largest RSRP, the terminal may select the LBL scheme in operation S741.

The LBL scheme may be a method of selecting a cell with the largest selection criterion value from the candidate base station. The LBL scheme may determine the selection criterion value determined in the LBL scheme based on the backhaul information of each cell.

The terminal may determine the candidate base station based on the LBL scheme as follows. The terminal may determine base stations whose ratio between the standard threshold and the transmission RSRP of the base station is less than or equal to the tolerable gap value as candidate base stations. The candidate base station may refer to a base station whose ratio between the standard threshold and the transmission RSRP of the base station is less than or equal to the tolerable gap value. In addition, the terminal may determine n* base stations as candidate base stations. The candidate base stations may refer to n upper base stations for received signals based on the standard threshold. Alternatively, the candidate base station may be determined from among base stations that have transmitted the RSRP value to the terminal.

In the LBL scheme, the selection criterion value for cell selection may use the RSRP value of each base station or values that can be expressed as ƒ(RSRPᵢ, Nᵢ). The selection criterion value may be defined as the RSRP value or a combination of ƒ(RSRPᵢ, Nᵢ). In addition, the selection criterion value may be determined based on cell selection parameters. For example, the selection criterion value can be expressed as Equation 3 or Equation 4.

The terminal may select the LBL scheme and may be connected to the base station with the largest value of ƒ(RSRPᵢ, Nᵢ) in operation S751. The base station with the largest value of ƒ(RSRPᵢ, Nᵢ) may be referred to as a target base station.

Meanwhile, based on the collected standard threshold, when there is no base station that provides the RSRP above a predetermined percentage (tolerable gap, x) of the standard threshold except for the base station that provides the largest RSRP, the terminal may select the Max RSRP scheme in operation S742. The Max RSRP scheme may be a method of selecting the cell that provides the largest RSRP.

The terminal may select the Max RSRP scheme and may be connected to the base station that has transmitted RSRPₘₐₓ in operation S752. The base station that has transmitted RSRPₘₐₓ may be referred to as the target base station.

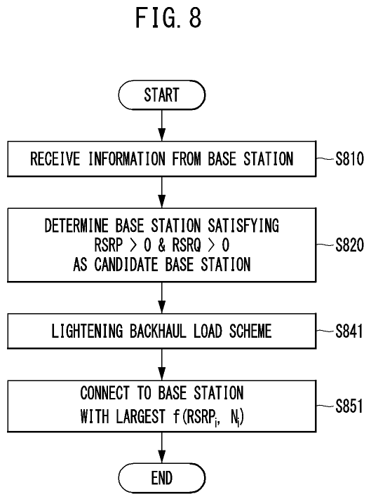

FIG. 8 is a flowchart illustrating a third embodiment of a method for connecting a terminal and a base station.

Referring to FIG. 8, the present disclosure may relate to a method for a terminal to perform a cell selection and reselection procedure based on information collected from a base station. FIG. 8 may illustrate a cell selection and reselection procedure based on NR. In addition, FIG. 8 may illustrate a cell selection procedure when the terminal does not receive a tolerable gap from the base station or the tolerable gap is not determined in advance.

The terminal may receive information transmitted from base stations in operation S810. The information received by the terminal may refer to a standard threshold. The information received by the terminal may refer to bits that specify the standard threshold. The terminal may perform the cell selection procedure based on the standard threshold.

The terminal may perform the procedure according to the LBL scheme in operation S841.

The LBL scheme may be a method of selecting a cell with the largest selection criterion value from a candidate base station. The LBL scheme may determine the selection criterion value determined in the LBL scheme based on backhaul information of each cell.

In Equation 1, dividing RSRP_{criteria} by RSRPᵢ and comparing the divided value with the tolerable gap may be to minimize performance degradation. Equation 1 may be used to reduce the number of links in the entire network.

In other words, when the terminal does not select the cell with the largest RSRP_{criteria}, but selects the cell with the largest selection criterion value, there may be a slight decrease in the received signal. In addition, the network may reduce the number of connection hops of the terminal, thereby reducing the number of links formed throughout the network. When the number of links formed throughout the network decreases, the limited amount of wireless resources used by the network decreases, which can be expected to reduce interference.

On the other hand, when the terminal does not divide the RSRP value for base station i and selects the base station with the largest selection criterion value including the number of hops, multiple base stations may be included as the candidate base stations. Therefore, there may be cases where a base station with a relatively weak signal strength is selected by the terminal.

Therefore, when the terminal determines the candidate base stations by comparing the transmission RSRP rate and tolerable gap values to be connected to the target base station, service performance degradation can be minimized and performance gains can be achieved due to a reduction in the number of links formed throughout the network.

The terminal may select the LBL scheme and may be connected to the base station with the largest value of ƒ(RSRPᵢ, Nᵢ) in operation S851. The base station with the largest value of ƒ(RSRPᵢ, Nᵢ) may be referred to as the target base station.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, the method comprising:
receiving cell selection and reselection criteria information broadcast from a base station;
determining candidate base stations among all base stations capable of communicating with the terminal based on the cell selection and reselection criteria information;
selecting one connection scheme from a lightening backhaul load (LBL) scheme or a maximum reference signal received power (RSRP) scheme based on a tolerable gap, which is a parameter for determining the candidate base station;
selecting one candidate base station from among the candidate base stations as a target base station based on the one connection scheme; and
connecting to the target base station.

2. The method of claim 1, wherein the determining of the candidate base stations among all base stations capable of communicating with the terminal based on the cell selection and reselection criteria information includes
selecting a base station whose RSRP, which is a measurement result of a reference signal (RS) received from the base station, is greater than or equal to a first threshold; and
selecting a candidate base station whose reference signal received quality (RSRQ), which is the measurement result of the RS received from the base station, is greater than or equal to a second threshold from the base station whose RSRP is greater than or equal to the first threshold.

3. The method of claim 1, wherein the selecting of the one candidate base station from among the candidate base stations as the target base station based on the one connection scheme includes,
selecting one or more candidate base stations from among the candidate base stations based on a quality threshold that is the received signal for all base stations, when selecting the LBL scheme; and
selecting the target base station from among the one or more candidate base stations.

4. The method of claim 3, wherein the selecting of the target base station from among the one or more candidate base stations includes connecting the base station with the largest selection criterion value for selecting the target base station among the one or more candidate base stations as the target base station.

5. The method of claim 4, further comprising:
calculating the selection criterion value based on at least one of a cell selection parameter, backhaul information, or the quality threshold.

6. The method of claim 1, wherein the tolerable gap is a ratio of the quality threshold, which is the received signal for all base stations, and the RSRP received from the base station.

7. The method of claim 1, wherein the tolerable gap is the number of upper base stations in a ranking of the base stations based on the quality threshold that is the received signal for all base stations.

8. A method of a base station, the method comprising:
transmitting a network environment parameter to a central server;
receiving a tolerable gap, which is a parameter for determining a candidate base station, from the central server to maximize the performance of a network metric set based on the network environment parameter;
generating cell selection and reselection information based on the network environment parameter and the tolerable gap; and
transmitting the cell selection and reselection information to a terminal.

9. The method of claim 8, wherein the network metric is generated based on a probability of communication success, which is a probability that the capacity of the terminal is greater than the capacity of the target service.

10. The method of claim 8, wherein the tolerable gap is a ratio of a quality threshold, which is a received signal for all base stations capable of communicating with the terminal, and an RSRP received from the base station,

11. The method of claim 8, wherein the tolerable gap is the number of upper base stations in a ranking of base stations based on the quality threshold, which is a received signal for all base stations capable of communicating with the terminal.

12. A terminal comprising:
at least one processor,
wherein the at least one processor causes the terminal to
receive cell selection and reselection criteria information broadcast from a base station;
determine candidate base stations among all base stations capable of communicating with the terminal based on the cell selection and reselection criteria information;
select one connection scheme from a lightening backhaul load (LBL) scheme or a maximum reference signal received power (RSRP) scheme based on a tolerable gap, which is a parameter for determining the candidate base station;
select one candidate base station from among the candidate base stations as a target base station based on the one connection scheme; and
connect to the target base station.

13. The terminal of claim 12, wherein, when the candidate base stations are determined among all base stations capable of communicating with the terminal based on the cell selection and reselection criteria information, the at least one processor causes the terminal to
select a base station whose RSRP, which is a measurement result of a RS received from the base station, is greater than or equal to a first threshold; and
select a candidate base station whose RSRQ, which is the measurement result of the RS received from the base station, is greater than or equal to a second threshold from the base station whose RSRP is greater than or equal to the first threshold.

14. The terminal of claim 12, wherein, when one candidate base station is selected from among the candidate base stations as the target base station based on the one connection scheme, the at least one processor causes the terminal to
select one or more candidate base stations from among the candidate base stations based on a quality threshold that is the received signal for all base stations, when selecting the LBL scheme; and
select the target base station from among the one or more candidate base stations.

15. The terminal of claim 14, wherein, when the target base station is selected from among the one or more candidate base stations, the at least one processor causes the terminal to connect the base station with the largest selection criterion value for selecting the target base station among the one or more candidate base stations as the target base station.

16. The terminal of claim 15, wherein the at least one processor causes the terminal to calculate the selection criterion value based on at least one of a cell selection parameter, backhaul information, or the quality threshold.

17. The terminal of claim 12, wherein the tolerable gap is a ratio of the quality threshold, which is the received signal for all base stations, and the RSRP received from the base station.

18. The terminal of claim 12, wherein the tolerable gap is the number of upper base stations in a ranking of the base stations based on the quality threshold that is the received signal for all base stations.
